(19) United States
(12) Patent Application Publication
(10) Pub. No.: US 2022/0307685 A1
(43) Pub. Date: Sep. 29, 2022

(54) Soleric Process for Enhancing Steam and Super-heated Steam Production from Small Concentrated Solar Power and Renewable Energy.

(71) Applicant: Eric Jose Marruffo, Redwood City, CA (US)

(72) Inventor: Eric Jose Marruffo, Redwood City, CA (US)

(21) Appl. No.: 17/211,892

(22) Filed: Mar. 25, 2021

(51) Int. Cl. F22G 1/06; F22G 3/00; F22G 5/20; F24S 80/10; F24S 23/30; F24S 30/40; F24S 70/20

(52) U.S. Cl. CPC F22G 1/06; F22G 3/006; F22G 5/20; F24S 80/10; F24S 23/31; F24S 30/40; F24S 70/20

(57) ABSTRACT

A process for enhancing boiling to generate steam and superheated-steam by using renewable energy from Concentrated Solar Power. Steam can generate electricity, heating and cooling, sterilization, and other processes and products. The embodiment is made of a light weight small assembly and rotates on the X and Y axis to align with the solar radiation. The assembly has a steam generation unit (28) with Fresnel lenses affixed to concentrate the solar radiation and generate heat. The focal point of the radiation being concentrated is directed to the inner side of a glass tube (30) covered with nanoparticles. The surface area being heated by the solar radiation is increased by the use of nano articles. Water atomization/aerosol unit (60) creates reduced size water droplets that are channeled to glass tube (30) and put into contact with the heated nanoparticles. The atomized/aerosol water droplets help reduce heat dissipation.

### CROSS-REFERENCE TO RELATED APPLICATIONS

This application claims the benefit of provisional patent application EFS ID: 38971609, Application Number: 62994847, Confirmation number: 7250, filed 2020 Mar. 26 by the present inventor.

### BACKGROUND

### Prior Art

Solar energy is harvested in many ways but most commonly by Concentrated Solar Power and photovoltaic solar panels. Concentrated Solar Power requires large amounts of space in order to collect the solar radiation and concentrate it into a single point to produce electricity from steam turbines. This forces the location of Concentrated Solar Power structures in remote areas where large amount of land is available and not so expensive. The large amount of area required by Concentrated Solar Power puts these structures far away from urban areas where the energy consumption is the highest and renewable low cost energy is needed the most. Photovoltaic solar panels are much less efficient than Concentrate Solar Power. Photovoltaic solar panels require the use of many panels interconnected with each other to produce enough electricity to fully power the energy requirements of an average home. The rate electricity generation of photovoltaic solar panels gradually reduces over time. The cost of photovoltaic solar panels and its installation is still too high for the mass use in homes across the world. The abundance of fossil fuels and atomic energy to produce electricity makes the research and development of improved Concentrated Solar Power technologies unnecessary.

Nevertheless, the increase of global warming, due to the use of fossil fuels, is pushing for the development of smaller and more effective Concentrated Solar Power technologies and processes that could be used in homes. Several designs of processes have attempted to improve the generation of steam for producing electricity and other uses, but have not significantly improved the steam generation rate nor reduced the area requirements of Concentrated Solar Power from the Prior Art. The existing designs of Prior Art that use Concentrated Solar Power to heat nanoparticles for steam production have the following flaws:
a) The nanoparticles are fully submerged in water and the excess water dissipates the heat energy.
b) The nanoparticles submerged in water are scattered around and moving in the volume of water varying the amount of water blocking and absorbing the solar radiation.
c) The loose nanoparticles moving in the volume of water block the solar radiation path to other nanoparticles and create a shadow effect.

### SUMMARY

In accordance with one embodiment a process for enhancing the production of steam and super-heated steam using renewable energy from a small Concentrated Solar Power assembly employing lenses to concentrate the solar radiation onto a focal point within the inner wall of a glass tube lined with fixed nanoparticles that come into contact with atomized/aerosol water.

### DRAWINGS

### Figures

In the drawings, closely related figures have the same number but different alphabetic suffixes.

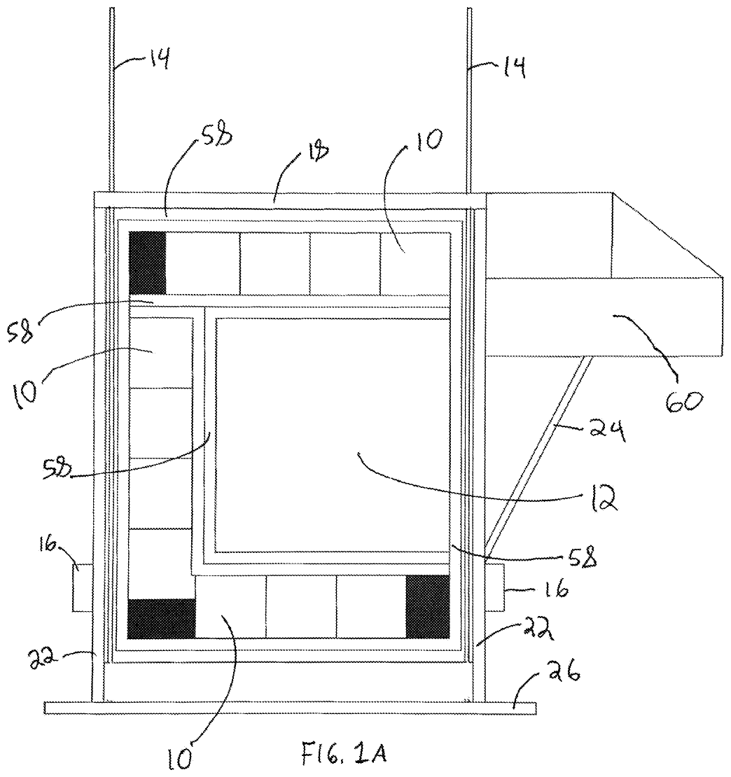

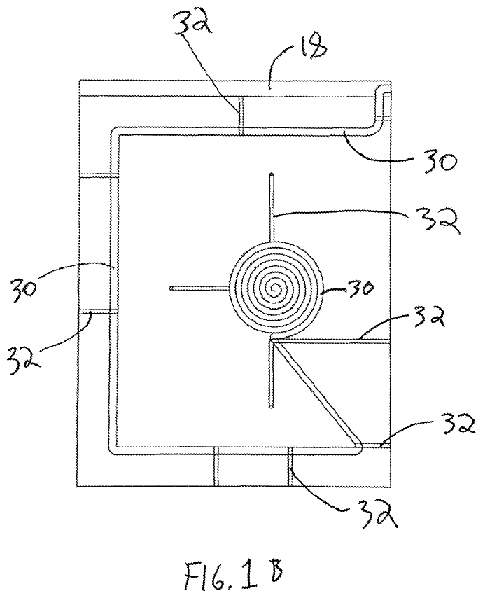

FIG. 1A shows the front view of the embodiment with the detail of the rectangular box where the Fresnel lenses will be attached to, the side legs supporting the embodiment, and the water atomization/aerosol unit (top right).

FIG. 1B shows the internal front view detailing the setting and arrangement of the glass tube as per the location of the Fresnel lens being used.

FIG. 2A shows the side view of the embodiment with the detail of the pyramid shaped back, the legs holding up the unit, and the water atomization/aerosol unit (top center).

FIG. 2B shows the internal side view of the glass tube, its location, support structure, and arrangement within the front (rectangular box) and back (pyramid).

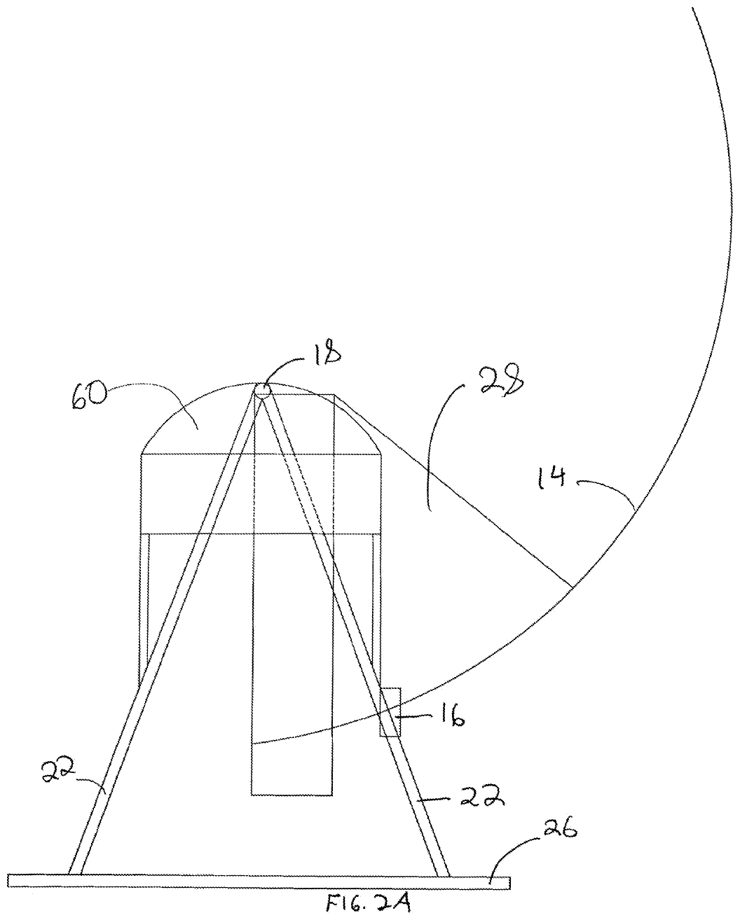

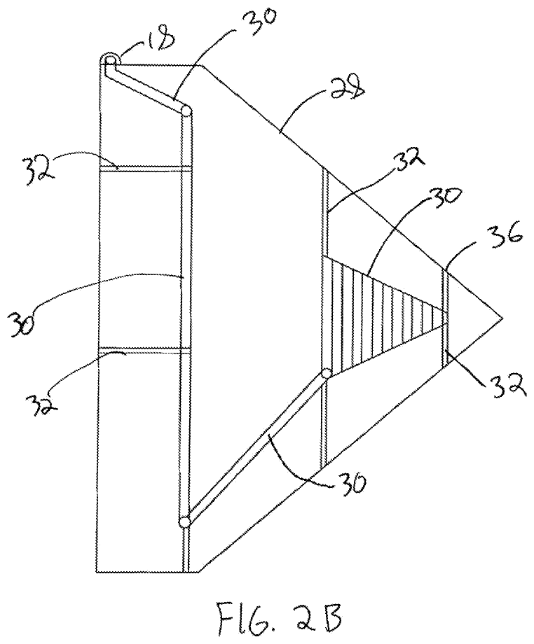

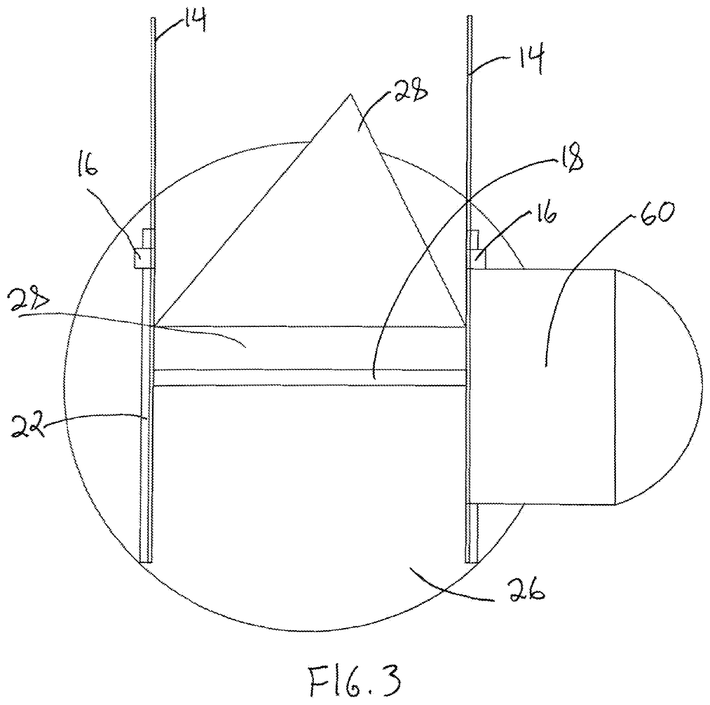

FIG. 3 shows the top view of the embodiment with the detail of the circular base where the embodiment will sit on and spin, the pyramid back (top center), and the water atomization/aerosol unit (left).

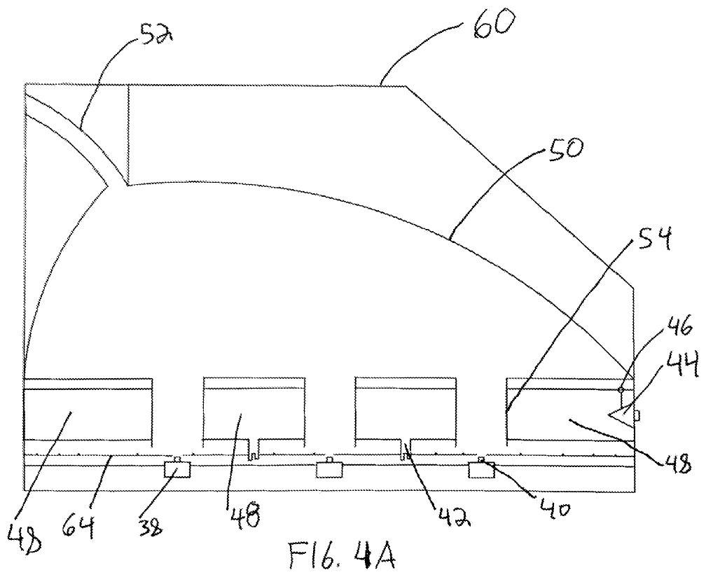

FIG. 4A shows the front view of the water atomization/aerosol unit with the internal detail.

FIG. 4B shows the top view of the water atomization/aerosol unit with the internal layout.

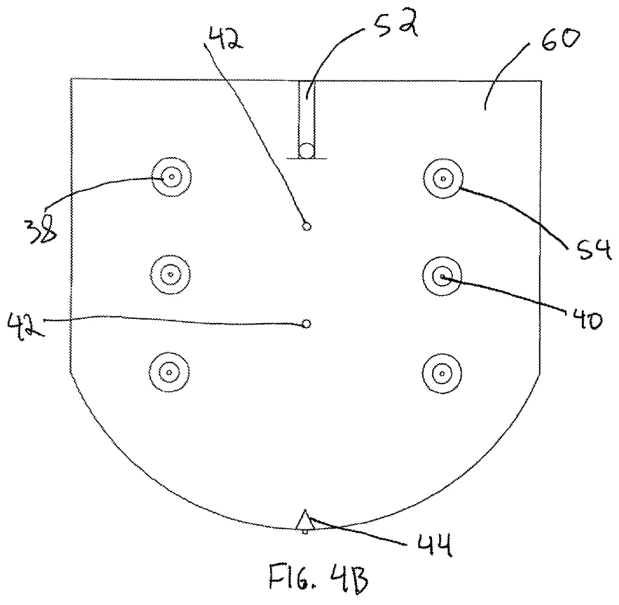

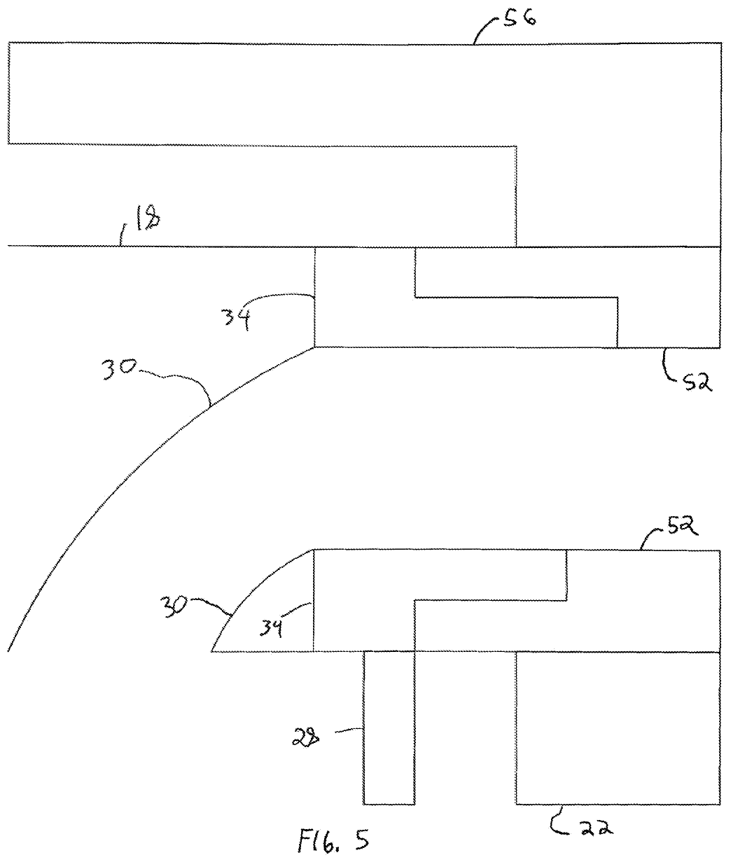

FIG. 5 shows the connection detail between the guide tube and the Teflon joint that will allow for the independent movement of the Fresnel lenses and glass tube structure from the water atomization/aerosol unit.

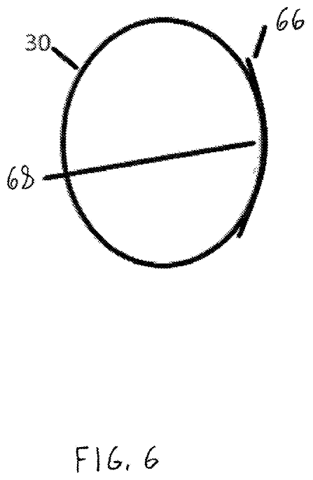

FIG. 6 shows a cross section view of the glass tube with the location of the magnetic strip on the outside of the tube and the nanoparticles inside being held in place by said magnetic strip.

Drawings—Reference Numerals

| | |
|---|---|
| 10 Linear focal point Fresnel lens | 12 Single focal point Fresnel lens |
| 14 Swivel track | 16 Swivel track motor circuit board |
| 18 Pendulum support bar | 20 Fresnel lenses frame |
| 22 Legs | 24 Water atomization/aerosol unit legs |
| 26 Rotating circular base | 28 Steam generation unit |
| 30 Glass tube | 32 Glass tube support |
| 34 Teflon joint | 36 Steam exhaust |
| 38 Circuit board | 40 Piezo/electromagnetic transducer |
| 42 Water valve | 44 Water intake |
| 46 Water intake valve | 48 Water holding tank |
| 50 Channeling dome | 52 Feeding tube |
| 54 Atomized/aerosol water guide | 56 Stability bar |
| 58 Aluminum sheet | 60 Water atomizer/aerosol unit |
| 62 Main water tank | 64 Water reservoir |
| 66 Magnetic strip | 68 Nanoparticles |

### DETAILED DESCRIPTION—FIGS. 1A, 1B, 2A, 2B, 3, 4A, 4B, 5, 6

### Embodiment

The embodiment of the process is illustrated in FIG. 1A (front view), FIG. 2A (side view), and FIG. 3A (top view). The embodiment's circular base, legs, steam generation unit, and water atomization/aerosol unit are all made of aluminum. The embodiment structure can be made of other materials as long as the overall weight is kept to a minimum and the strength sufficient to withstand the requirements. The embodiment will receive 24 volts of direct current electricity from a conventional 24 volt 100 Ah lithium battery. The battery will be powered by four conventional 12 volts 300 watts solar panels. The solar panels will be arranged in two groups. Each solar panel group will be comprised of two solar panels that will be connected in series to obtain 24 volts. The two 24 volts groups of solar panel connected in series will be connect to each other in parallel. The solar panels and the battery will be placed adjacent to the embodiment. The embodiment can be powered by any means of renewable energy producing any amount volts, wattage, and amps in either direct or alternate current. The electricity produced by the renewable energy can be stored by any means or method.

The embodiment can be designed as a close circuit in order to recirculate and re-use the steam generated. The steam will be turned into water by condensation or any other physical, chemical, or mechanical action. The water will then be reintroduced to water atomizer/aerosol unit 60.

The front rectangular box illustrated in FIG. 1A, will have thin sheets of aluminum 58 on the inside border of the box and in between the lenses edges to hold the lenses from the back. These thin aluminum sheets 58 will be 2 millimeters thick and 50 millimeters wide. These thin aluminum sheets 58 surrounding the inside border of the box and between the lenses will be welded to the box and in every connection for added support. A second set of thin aluminum sheets 58 will be placed in the same location as the first but in front of the lenses. This second set of thin aluminum sheets 58 will be secured onto the first with conventional metal screws. The screws will be placed in the approximate 5 millimeter space in between the locations of the lineal focal point Fresnel lenses 10 and the location of the single focal point Fresnel lens 12. Ten screws will be used and, placed equidistance to each other. The arrangement of thin aluminum sheets will hold the lenses in place and prevent them from being blown off by strong winds. Acrylic Fresnel lenses were used to concentrated light in the embodiment because of the lenses' light weight. Various manufacturers, such as SIX SEASONS TECH or NTKJ CO.,LTD. can manufacture the Fresnel lenses needed for the embodiment.

The linear focal point Fresnel lenses will be placed on the inside edges of the rectangular box illustrated in FIG. 1A. The configuration of these lenses will be on the top, left, and bottom edges of the rectangular box.

The linear focal point Fresnel lenses will be of 30 cm×30 cm in size with a focal point of 30 cm. The linear focal point Fresnel lens will have a thickness of 2 millimeters and a groove pitch of 1 millimeter.

The single focal point Fresnel lens will be placed in center right of the rectangular box illustrated n FIG. 1A., filling the remaining area of the box. The single focal point Fresnel lens will be 100 cm×100 cm in size with a focal point of 120 cm, The single focal point Fresnel lens will have a thickness of 3 millimeters and a groove pitch of 1 millimeter. In my test, linear focal point Fresnel lens 10 was able to heat a metal surface in contact with the light at the focal point to temperatures between 250 to 300 degrees Fahrenheit. The single focal point Fresnel lens 12 was able to heat a metal surface in contact with the light at the beginning of the focal point's cone connection to a temperature of 250 degrees Fahrenheit. The single focal point Fresnel lens 12 was able to heat a metal surface in contact with the light at the focal point to a temperature of approximately 600 degrees Fahrenheit.

The lenses used in the embodiment could be made of any different type, structure, or shape instead of Fresnel lens and the embodiment could also use any different type of Concentrated Solar Power technology to concentrate the sun rays. The arrangement of the Fresnel lenses in the embodiment could be done in any other different order or location. The embodiment is not limited to using any particular type of Fresnel lens and could include or omit single focal point, linear focal point, and any other Fresnel lens light concentration focal point pattern to collect the suns energy.

The steam generation unit 28 is comprised of the rectangular box and the pyramid illustrated in FIGS. 1A, 2A, and 3A. This unit is where the sun light will be concentrated by the Fresnel lenses and put into contact with the nanoparticles inside the glass tube 30.

The steam generation unit 28 will be attached to an aluminum tube on the top called the pendulum support bar 18. The pendulum support bar 18 will be connected to the side legs intersection at the top on both sides. The side of the water atomizer/aerosol unit 60, will be connected to the steam generation unit 28 by a Teflon lined joint. The Teflon joint 34 will allow the connection and continuity between feeding tube 52 and the glass tube 30.

The Teflon joint will also permit the swivel movement of the steam generation unit 28. On the opposite end of the pendulum support bar 18 the side legs 22 will be connected to it by a wheel bearing. To provide stability to the embodiment at the top, an aluminum laminate will be welded from one end of the supporting legs 22 junction to the other end parallel to the pendulum support bar 18. The parallel aluminum laminate will be of approximately 15 millimeters in thickness and with a separation from the pendulum support bar 18 of approximately 15 millimeters.

The glass tube 30 will be made of a 1 millimeter thickness and a diameter of approximately 33 millimeters. The glass tube can be made of any type of glass such as Corning Valor glass used in glass vials or Pyrex.

The glass tube 30 can also be made of other types of glass or materials as long as the material is strong enough, can withstand heat of 800 degrees Fahrenheit and allow for light transmission. The glass tube 30 can be made of any other type of material as long as it is translucent enough to allow for the optimal amount of solar radiation to pass through and heat the nanoparticles. The glass tube 30 can also be made of any other diameter and wall thickness.

The glass tube 30 will be placed inside of the steam generation unit 28 to intersect the focal point of the Fresnel lenses. The glass tube 30 alignment starts immediately after it enters the steam generation unit 28 and starts with the layout of the finer focal point Fresnel lenses 10. The glass tube 30 will be placed to intersect the focal point of the linear focal point Fresnel lenses 10 attached to the inner edge of the rectangular box. The glass tube 30 will stop this alignment once it reaches the last linear focal point Fresnel lens 10 at the bottom right of the rectangular box. This routing is shown in illustrations FIGS. 1B and 2B.

The single focal point Fresnel lens 12 concentrates the light it captures into one single point. The single focal point Fresnel lens 12 will have the focal point 1200 millimeters perpendicular to the Fresnel lens' center. The light is directed and concentrated to a single focal point resembling the shape of a cone. The single focal point could be imagined as the tip of the cone. The glass tube 30 will then be directed to intersect the single focal point Fresnel lens 12 outer cone light path starting at 750 millimeters perpendicular from the center of the lens. The glass tube 30 will be aligned to and shaped to intersect the outer cone light path of single focal point Fresnel lens 12.

The glass tube 30 will be spun in circles that reduce their diameter conforming to the shape of the single focal point Fresnel lens' 12 outer cone light path. The conforming of the glass tube 30 will continue towards the focal point of single focal point Fresnel lens 12 until only a 15 millimeter distance remains to reach the focal point. The glass tube 30 will then conform to a circle to intersect the focal point's approximate diameter of 25 millimeters. The glass tube 30 will then end its trajectory in steam exhaust 36 towards the top of the pyramid shape back. The location and alignment of the glass tube 30 to intersect the light gathered by single focal point Fresnel lens 12 is illustrated in FIGS. 1B and 2B.

The location of glass tube 30 will be precisely set to intersect the light from the Fresnel lenses' focal points with the nanoparticles attached to the inner wall of glass tube 30. The nanoparticles will be attached to the opposite side of the glass tube where the light first contacts the glass tube 30 as illustrated in FIG. 6.

The nanoparticles will be held in place on the inner wall of glass tube 30 by a flexible magnetic strip glued to the outside of glass tube 30. The magnetic strip will be held in place by a thin layer of conventional strong heat resistant glue such as JB Weld Extreme Heat glue. The nanoparticles to be used in the embodiment will be made from Silver (Ag) metal and hydrophilic. The nanoparticles will be of 3 nanometers in size. The Silver nanoparticles can be obtained from companies such as: Cerion Nanomaterials or NanoComposix.

The nanoparticles could also be obtained in the laboratories of universities in the United States that focus in nanoparticle study and development. The total amount of nanoparticles to be used for the embodiment will be 3 grams. The attachment of the nanoparticles to glass tube 30 will be done in sections in order to evenly spread the nanoparticles along glass tube's 30 length. The glass tube's 30 length will be divided into 10 equal distance sections. The 3 grams of Silver nanoparticles will be divided into 10 equal weight portions to be used in the 10 equal length section of glass tube 30.

The first section will start from the end of the single focal point Fresnel lenses 12 location at the steam exhaust 36 and follow the path of glass tube 30 until the last section reaches linear focal point Fresnel lens 10 next to the Teflon joint inside pendulum support bar 18. Each section, starting from steam exhaust 36 to the last, will have the magnetic strip glued first and then the nanoparticles introduced to the tube in water. The corresponding portion of nanoparticles by weight for each section will be introduced in the water and allowed to evenly attach to the wall with the magnetic strip. The water in each section will be held by an inflatable cylinder balloon which will provide water tightness. The water will be drained from each section after the nanoparticles are completely affixed to the wall of glass tube 30 with the magnetic strip glued to the outside of glass tube 30. The balloon will be moved to the beginning of the next section and inflated again by a tube attached to the balloon and covering the total length of glass tube 30.

The nanoparticles or micro-particles in the embodiment can be made of any other metal element or any other element of the periodic table of elements or composition thereof as long as the properties of the element or the tuning of the particles created provide for the best absorption of the sun's radiation and the transfer of heat. The size of the nanoparticles can vary from 1 nanometer to 100 nanometers with no restriction on the size to be used. The embodiment can also use any metallic particles of any microns size or particles of any microns size of any element in the periodic table of element or composition thereof. The amount of the nanoparticles or micro particles to be used can be of any weight. The nanoparticles or micro particles that can be used can be hydrophilic or hydrophobic. The use of nanoparticles increases the surface area being heated and enhances the boiling of water.

In order for the embodiment's steam generation unit 28 to work effectively, the rectangular box must be perpendicularly aligned to the solar rays once the sun light is visible in the horizon. The steam generation unit 28 must be kept perpendicular to the solar rays during the hours of light during the day and the trajectory of the sun depending on the location on earth and time of the year. To achieve this objective the embodiment is mounted on a rotating circular base 26 that provides for 360 degree movement using 3 conventional 24 volt electrical motors. The rotating circular base 26 will be resting on three wheel bearings that will allow the movement to happen and will distribute the weight on the base evenly. This movement range, provided by the rotating circular base 26, will position the steam generation unit 28 and the rectangular box holding the Fresnel lenses on the correct Azimuth angle. The Azimuth angle is the compass direction from where the sunlight is corning.

The steam generation unit 28 will be attached and hung from pendulum support bar 18. Pendulum support bar 18 will be connected and help up by the legs 22 with the Teflon joint 34 on the right side and the wheel bearing on the left side. This description can be visualized if seen from the perspective of illustration FIG. 1A. The legs 22 will provide support to the steam generation unit 28 and water atomizer/aerosol unit 60.

The steam generation unit 28 will swing forward and backward. This movement can be imagined when viewing the steam generation unit 28 from the perspective of illustration FIG. 1A. The same movement is to be imagined for the steam generation unit 28 when viewed from the perspective of illustration FIG. 2A. In this latter perspective, the movement is from left to right or right to left. This movement for steam generation unit 28 will he achieved and controlled by each of the 24 volt conventional electrical motors on both sides of the Swivel track motor circuit board 16 and guided by the swivel tracks 14. Two swivel tracks 14 will be used in the embodiment. The first swivel track 14 will be located on the left side of the embodiment as illustrated in FIG. 1A. The second swivel track 14 will be located on the right side of the embodiment as illustrated in FIG. 1A. Each swivel track 14 will be placed between steam generation unit 28 and legs 22. The movement rage provided by the Swivel track motor circuit board 16 and swivel track 14 will allow the steam generation unit 28 to align with the Elevation/Altitude angle. The Elevation/ Altitude angle is the angular height of the sun in the sky measured from the horizon.

The embodiment needs to be able to align the steam generation unit's 28 rectangular box perpendicularly to the sun rays during the sun's movement in the day light hours. This motion will be controlled by a computer with an atomic clock signal receiver and a GPS within the Swivel track motor circuit board 16. Conventional celestial body tracking formulas will be programed in the computer inside Swivel track motor circuit board 16 to use the GPS signal and exact time of day for the correct computation of the Azimuth and Elevation/Altitude angles. The Azimuth angle and the Elevation/Altitude angle calculated will correctly direct a computer program to active the motors and move the rotating circular base 26 and the steam generation unit 28 in the right direction and proportion to continuously track the sun rays and align perpendicularly the rectangular box housing the Fresnel lenses during the daylight hours.

The water atomizer/aerosol unit 60 will be attached to the top of legs 22 on the right side of the embodiment as illustrated in FIG. 1A. The water atomizer/aerosol unit 60 will be further supported by water atomizer/aerosol unit legs 24 as illustrated in FIG. 1A. The water atomizer/aerosol unit 60 will have a water intake 44 that will provide the water amount needed for the unit. Water intake 44 will be connected on the outside of atomizer/aerosol unit 60 to a conventional home water house or water supply. Water intake 44 will have a nozzle design to increase the water pressure into water atomizer/aerosol unit 60 to approximately 90 PSI. Water intake 44 will have water intake valve 46 connected to it by a metal rod. Water intake valve 46 will be attached to a float on the water surface of main water tank 62 to open or close a valve in water intake 44.

The water intake valve 4 is activated to let more water in through water intake 44. The activation of water intake valve 46 will happen when the water level in main water tank 62 is reduced by the water being atomized/aerosol in water reservoir 64. The water in main water tank 62 is channeled to water reservoir tank 64 by water valve 42. Water valve 42 controls the water coming into water reservoir tank 64 by water deferential, Water atomizer/aerosol unit 60 has six electromagnets 38 placed at the bottom of as illustrated in FIG. 2A. Each Circuit board 38 has a Piezo/electromagnetic transducer 40 attached on top. The Piezo/electromagnetic transducer 40 is placed under the water level of water reservoir 64 at approximately 10 millimeters in depth. The depth at which the Piezo/electromagnetic transducer 40 is placed in the water reservoir 64 can be higher or lower. The Circuit board 38 will be powered by a 24 volts power supply cable channeled through the inner cavity of water atomizer/aerosol unit legs 24.

The Circuit board 38 will be connected and controlled by a regulating device inside Swivel track motor circuit board 16. The connection of Circuit board 36 and the regulating device inside Swivel track motor circuit board 16 will run through the inner cavity of water atomizer/aerosol unit legs 24. The Circuit board 38 will provide for the power and control of the vibrating/oscillating movement of Piezo/electromagnetic transducer 40. The ultrasonic vibrating/oscillating movement of Piezo/electromagnetic transducer 40 will turn the water directly above it into an atomization or aerosol.

The atomization/aerosol water will rise through atomized/aerosol water guide 54 and concentrate in channeling dome 50. The continuous production of atomized/aerosol water by Piezo/electromagnetic transducer 40 will push the atomized/aerosol water in channeling dome 50 into feeding tube 52. Feeding tube 52 will have three fins inside that will force the atomized/aerosol water going through it to organize and spin like a cyclone. The cyclone effect will make the atomized/aerosol water to move faster through feeding tube 52, into joint Teflon joint 34, and forward to glass tube 30. The atomization/aerosol of water reduces the dissipation of the heat when the atomized/aerosol water comes into contact with the nanoparticles.

The location, size, water depth and separation of the Piezo/electromagnetic transducer 40 can vary in the water atomizer/aerosol unit 60 layout. The materials and dimensions of Piezo/electromagnetic transducer 40 can vary. The location, size, and separation of the Circuit board 38 can vary in the water atomizer/aerosol unit 60 layout. To obtain the most effective and abundant production and flow of atomized/aerosol water to the channeling dome 50 and feeding tube 52, the embodiment's configuration and arrangement of the internal parts for atomizer/aerosol unit 60 can fluctuate.

Any internal part of atomizer/aerosol unit 60 can be made of any material. The water in atomizer/aerosol unit 60 can be atomized or aerosol by any chemical, electrical, or mechanical means. The location of atomizer/aerosol unit 60 can be anywhere on the embodiment. The location and connection of atomizer/aerosol unit 60 to steam generation unit 28 can be anywhere in the embodiment. Conventional parts will be used for Circuit board 38 and Piezo/electromagnetic transducer 40.

The embodiment's steam generation unit 28 can also be heated by the energy produced using a Laser beam. The Laser's beam can be routed to come into contact with the nanoparticles in glass tube 30 using optics and mirrors. The Laser can be powered using energy stored in a lithium battery charged by other renewable energy sources. The laser used can be of solid-state, Gas, Liquid, or Semiconductor type as long as it produces the maximum amount of heat while consuming the least amount of electric power. The Laser beam's heat could be used to power the embodiment's steam generation unit 28 during periods of cloud cover blocking the sun's light and radiation. The Laser beam's heat could be used to power the embodiment's steam generation unit 28 during night time.

The embodiment is not limited to tracking the solar rays using movement. The embodiment can use a different structure and have an optical lens such as solid immersion aspheric converse lens or a solid immersion super sphere to collect and concentrate the solar rays. Solid immersion lenses use water inside of them or are submerged in water. Water can bend light, refraction, which allows for the collection of the solar rays at lower elevation angles.

The collected solar rays will then be redirected using optical image stabilization technology to continuously align the solar rays with the glass tube 30. The embodiment can use any type of optical lenses. The embodiment can use optical lenses made of any material. The embodiment can use optical lenses and place them in any location of the current embodiment design or a new embodiment design.

### GLOSSARY

Nanoparticles: Is a particle that has the size of one billionth of a meter.
Fresnel lens: A type of light concentrating lens that is much thinner than a comparable conventional lens.
Focal point: The distance at which a lens focuses the light into a single point from the light collecting surface of the lens.
Concentrated Solar Power: Any system designed to concentrate solar light using mirrors or lenses onto a receiver.
Hydrophilic: Something that can mix with water.
Hydrophobic: Something that. does not mix or repels water.
Micro-particle: Is a particle that has a size of one Millionth of a meter.
Aspheric convex lens: Is a lens with the light absorbing side made of a curvature not resembling a sphere or cylinder and an opposite side resembling a sphere.
Solid immersion lens: A solid immersion lens is a lens that uses the light refraction property of liquids, such as water or oil, to increase the magnification and light gathering power of a lens.
Super-Sphere solid immersion lens: A lens that resembles a sphere and has either liquid inside or is submerged in a liquid.
Azimuth angle: is the location of the Sun when viewed from the perspective of a Compass having the North as zero degrees and the movement being clockwise.
Elevation angle: Is the height of the Sun, measured in an angle, from the perspective of the viewer's horizon and the altitude of the location.

### Operation

The process will require the installation, on the evening before, of a fully charged battery for the computer and the circuit boards to operate correctly. The embodiment will have a manual for the operator to install the required battery, water line, turn on computer and where and how to input the date. The computer will receive the date input by a numerical key pad outside Swivel track motor circuit board 16. The computer will verify that the battery is fully charged before starting the process.

The computer will test the signal acquisition of the GPS and the Atomic clock. The computer will use the longitude and latitude provided by the GPS and the time provided by the Atomic clock to start the calculations of the celestial body tracking formula for the Sun. The calculations wilt give the computer program the time when the sunrise begins the following day. The computer program will test, 10 minutes before sunrise, the movement of the motors for possible obstructions. 15 minutes after sunrise, the computer will align the embodiment as per the azimuth angle location and elevation angle location and position steam generation unit 28 rectangular box directly perpendicular to the solar radiation coming from the geometrical center of the Sun.

Immediately after the alignment with the Sun, the computer will activate the Piezo/electromagnetic transducer 40 and begin the production of atomized/aerosol water, The atomized aerosol water will concentrate in channeling dome 50 and begin flowing through feeding tube 52. The atomized/aerosol water will move from feeding tube 52 through the connection joint and into glass tube 30. The fins inside feeding tube 52 will make the atomized/aerosol water move in a spinning manner such as a cyclone and accelerate the movement through glass tube 30.

Once in glass tube 30, the atomized/aerosol water will begin to make contact with the nanoparticles many times because of the cyclone spinning motion. The continued contact with the nanoparticles being heated by linear focal point Fresnel lenses 10, inside glass tube 30, will rapidly turn the water into steam. The steam moving through glass tube 30 in the single focal point Fresnel lens path will gradually increase its temperature to 600 degrees Fahrenheit. As the steam is pushed from the linear focal point Fresnel lens 10 route to the single focal point Fresnel lens 12 path, the steam will start to further increase its temperature and turn into super-heated steam,

### ADVANTAGES

From the description, a number of advantages of the embodiment become evident:
(a) The transformation of water into an atomized/aerosol form reduces the heat dissipation of bulk water when in contact with nanoparticles.
(b) By using electronically controlled piezo/electromagnetic transducers, the vibration/oscillation can be determined and the amount of water being transformed into atomized/aerosol droplet measured.
(c) The use of Fresnel lenses reduces the embodiment's weight.
(d) Using different focal point types of Fresnel lenses increases the heat source area to contact the nanoparticles.
(e) Using metallic nanoparticles allows for the alignment and fixation of the nanoparticles using magnets.
(f) Alignment and fixation of the nanoparticles permits more effective contact with the heat source.
(g) The use of nanoparticles helps to reduce the embodiment size, compared to typical CSP process dimensions and area requirements, because of the nanoparticles increased surface area properties.
(h) Metallic nanoparticles can be designed or tuned to absorb more of the suns solar energy radiation and thus converting more light into heat.
(i) Other heat sources, such as a Laser beam, could be used to power the steam generation unit 28.

### CONCLUSION, RAMIFICATIONS, AND SCOPE

The steam and super-heated steam generated by the process can be used to generate electricity, home heating and cooling, sterilization, and many other processes and by products derived from steam power. The embodiment's reduced size can avow for its installation in many building's where the area exposed to solar radiation is limited. The process can be used to produce electricity in remote locations were the electric grid is not available. The embodiment could be placed on to mobile platforms to provide electricity to locations impacted by natural disasters. The embodiment could be placed on to mobile platforms to provide seasonal high demand areas with electric vehicle charging stations.

Although the description contains many specificities, these should not be construed as limiting the scope of the embodiment but as merely providing illustration of some of several embodiments. For example, the steam generation unit 28 could be made smaller and of a different shape such as circular, oval, etc.; the embodiment could rest on a 3 axis gimbal, etc.

Thus the scope of the embodiment should be determined by the appended claim and their legal equivalents, rather than by the example given.

I claim:

1. A process for enhancing the production of steam and super-heated steam using renewable energy from a small Concentrated Solar Power assembly to heat nanoparticles and expose said nanoparticles with atomized/aerosol water, comprising:
a. concentrating solar radiation by using optical lenses arranged within a small assembly and
b. directing the focal point of the concentrated solar radiation onto said nanoparticles fixed to a glass tube
c. feeding said atomized/aerosol water moving in a spinning motion onto said fixed nanoparticles, whereby steam and super-heated steam is created.
